(19) United States
(12) Patent Application Publication
(10) Pub. No.: US 2025/0237739 A1
(43) Pub. Date: Jul. 24, 2025

(54) PMCW RADAR DEVICE AND CONTROL METHOD THEREOF, AND OBJECT DETECTION APPARATUS

(71) Applicant: Electronics and Telecommunications Research Institute, Daejeon (KR)

(72) Inventors: Byung Jang Jeong, Daejeon (KR); HYUNGJU KIM, Daejeon (KR); SUNGJIN YOO, Daejeon (KR); Jung Suk Joo, Daejeon (KR)

(21) Appl. No.: 19/025,122

(22) Filed: Jan. 16, 2025

(30) Foreign Application Priority Data
Jan. 19, 2024 (KR) 10-2024-0008813

(51) Int. Cl. G01S 7/35; G01S 13/58; G01S 13/931

(52) U.S. Cl. CPC G01S 7/356; G01S 13/584; G01S 13/931

(57) ABSTRACT

A phase modulated continuous wave (PMCW) radar device according to an embodiment disclosed in this document includes a code sequence generation module that generates an integrated code sequence by concatenating an inner code sequence and an outer code sequence in a specified scheme, the inner code sequence and the outer code sequence being different binary code sequences, a transmission module that generates a continuous wave by performing phase modulation on a carrier using the integrated code sequence and transmits the continuous wave, and a reception module that receives a signal of the continuous wave reflected by a nearby object, performs digital conversion on the received signal to generate a baseband signal, sequentially performs a correlation operation on the baseband signal with the inner code sequence and the outer code sequence, and performs a fast Fourier transform (FFT) operation on a result of the correlation operation.

### CROSS-REFERENCE TO RELATED APPLICATION

This application claims priority to and the benefit of Korean Patent Application No. 10-2024-0008813, filed on Jan. 19, 2024, the disclosure of which is incorporated herein by reference in its entirety.

### BACKGROUND

### 1. Field of the Invention

Various embodiments disclosed in this document are related to phase modulated continuous wave (PMCW) radar technology.

### 2. Discussion of Related Art

Radar is utilized in many industrial fields as a method of detecting the surrounding environment using radio waves and estimating the distance and speed of a target object. Radars are utilized in various ways such as pulse radar, ultra-wide band (UWB) radar, continuous wave (CW) radar, and frequency modulated continuous wave (FMCW) radar. For example, a pulse radar can emit radio wave pulses to measure a distance between radar system and object, and a CW radar can measure the speed of an object based on a frequency changed by the movement of an object using continuous radio waves. Radar technology is developing in forms suitable for its application fields. Vehicle radars are being developed for driver assistance functions such as advanced driver assistance systems (ADASs) and autonomous driving systems.

Related art of vehicle radar system has mainly used radar system implemented using an FMCW radar. However, an FMCW radar system generates a chirp signal in the analog stage, and thus precise processing is difficult.

### SUMMARY OF THE INVENTION

As next-generation radar technologies, methods such as phase modulated continuous wave (PMCW) and orthogonal frequency division modulation (OFDM) are attracting attention.

PMCW and OFDM radar systems process most of transmission and reception processing, including radar waveform generation, in the digital domain. Therefore, PMCW and OFDM radar systems can be precisely manufactured and can provide excellent performance.

A PMCW radar system can generate radar waveforms by performing phase modulation on a carrier signal using code sequence generated in the digital domain. In general, in terms of system complexity and performance, it can be advantageous to use a code sequence that has excellent auto-correlation and cross-correlation characteristics among sequences having a binary phase.

A PMCW radar system uses a code sequence with high auto-correlation and low cross-correlation characteristics for radar signal detection performance. For example, a maximal length sequence (m-sequence) or Legendre sequence can be used as a code sequence. However, these code sequences have a limited number of available sequences corresponding to the maximum length. Therefore, as the density of code sequence-based radar devices increases, interference can occur between code sequences.

Various embodiments disclosed in this document may provide a PMCW radar device, a PMCW radar control method, and an object detection apparatus that can reduce interference between code sequences.

According to an embodiment of the present invention, there is provided a phase modulated continuous wave (PMCW) radar device including a code sequence generation module that generates an integrated code sequence by concatenating an inner code sequence and an outer code sequence in a specified scheme, the inner code sequence and the outer code sequence being different binary code sequences, a transmission module that generates a continuous wave by performing phase modulation on a carrier using the integrated code sequence and transmits the continuous wave, and a reception module that receives a signal of the continuous wave reflected by a nearby object, performs digital conversion on the received signal to generate a baseband signal, sequentially performs a correlation operation on the baseband signal with the inner code sequence and the outer code sequence, and performs a fast Fourier transform (FFT) operation on a result of the correlation operation.

According to an embodiment of the present invention, there is provided a phase modulated continuous wave (PMCW) radar control method including generating an inner code sequence and an outer code sequence, the inner code sequence and the outer code sequence being different binary code sequences, generating an integrated code sequence using the inner code sequence and the outer code sequence, transmitting a continuous wave generated by performing phase modulation on a carrier using the integrated code sequence, performing digital conversion on a continuous wave received after being transmitted and the reflected by a nearby object to generate a baseband signal, detecting a delay of the continuous wave by sequentially performing a correlation operation on the baseband signal with the inner code sequence and the outer code sequence, and detecting a Doppler effect by performing a fast Fourier transform on a result of the correlation operation.

According to an embodiment of the present invention, there is provided an object detection apparatus that detects an object using a vehicle radar, including a memory in which at least one instruction for detecting an object is recorded, and a processor that executes the at least one instruction, in which the at least one instruction is executed to perform generating an integrated code sequence using an inner code sequence and an outer code sequence different from each other, grouping the integrated code sequence into a first specified number of sub-sequences after performing phase modulation on the integrated code sequence and transmitting the grouped integrated code sequence, performing digital conversion on a signal received after being transmitted and then reflected by a nearby object to generate a baseband signal, sequentially performing a correlation operation on the baseband signal with the inner code sequence and the outer code sequence and performing a fast Fourier transform on a result of the correlation operation, and detecting movement of the object based on a result of the fast Fourier transform.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows an implementation environment of a vehicle radar system according to an embodiment;

FIG. 2 shows a configuration diagram of a phase modulated continuous wave (PMCW) radar device according to an embodiment;

FIG. 3 shows a detailed configuration diagram of a digital processing part of a reception module according to an embodiment;

FIG. 4 shows correlation operation values between two different m-sequences when a code sequence period L=1024;

FIG. 5 shows a configuration diagram of a PMCW radar device according to an embodiment;

FIG. 6 shows a detailed configuration diagram of a digital processing block according to an embodiment;

FIG. 7 is a diagram illustrating a comparison of subframe structures according to a single code sequence and an integrated code sequence;

FIG. 8 shows a configuration diagram of an object detection apparatus according to an embodiment; and

FIG. 9 shows a flowchart of a PMCW radar control method according to an embodiment.

In relation to the description of the drawings, the same or similar reference numerals may be used for the same or similar components.

### DETAILED DESCRIPTION OF EXEMPLARY EMBODIMENTS

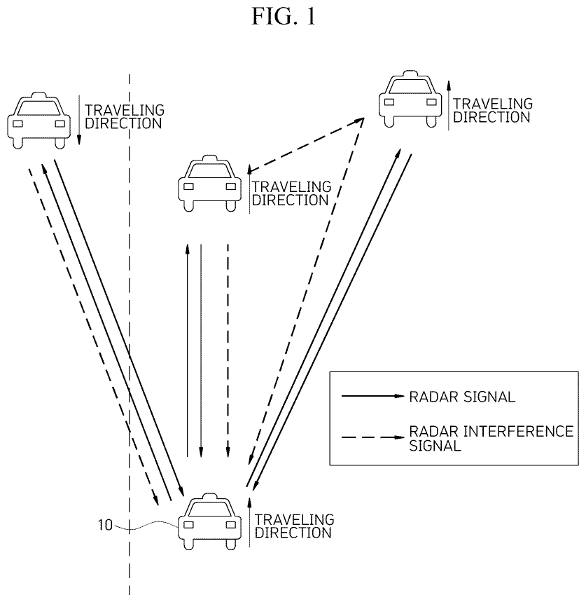

FIG. 1 shows an implementation environment of a vehicle radar system according to an embodiment.

Referring to FIG. 1, a vehicle radar system 10 according to the embodiment may be equipped with radars in a plurality of parts of a vehicle to observe a plurality of directions (e.g., forward, lateral, and rearward) from the vehicle. For example, a vehicle's front radar may be used to detect the speed and relative distance of vehicles ahead. The vehicle's front radar may directly receive radar signals from other vehicles with or without being reflected from an object. In this case, radar signals from other vehicles may act as interference signals for the vehicle's own received signal. Furthermore, the interference signal directly received without reflection may have a non-negligible magnitude. Fortunately, the vehicle radar system 10 may detect the vehicle's own received signal by performing a correlation operation on a received signal using a code sequence applied to a transmitted signal. This will be described in detail below.

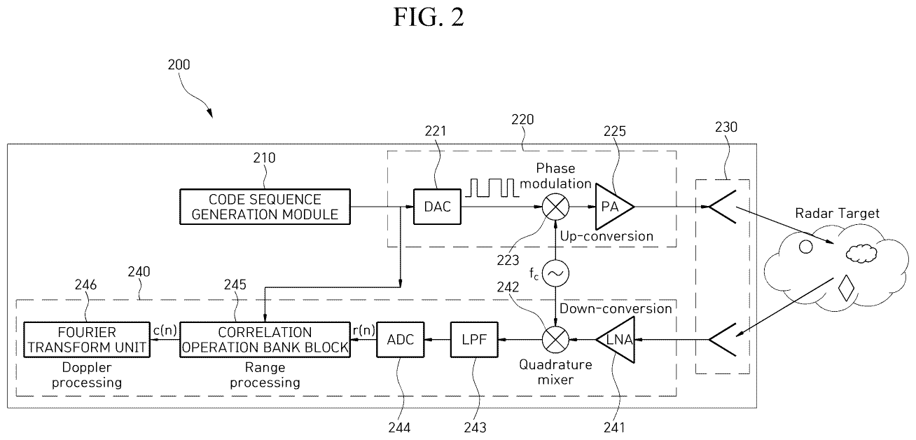

FIG. 2 shows a configuration diagram of a phase modulated continuous wave (PMCW) radar device according to an embodiment.

Referring to FIG. 2, a PMCW radar device 200 according to the embodiment may include a code sequence generation module 210, a transmission module 220, a reception module 240, and an antenna 230.

The code sequence generation module 210 may generate an m-sequence, a Legendre sequence, or an arbitrary binary code sequence. For example, the code sequence generation module 210 may include a linear feedback shift register (LFSR) that generates an arbitrary binary code. As another example, the code sequence generation module 210 may generate a code sequence by using a sequence set stored in a storage device in a logically equivalent form or by another method.

The transmission module 220 may include a digital to analog converter (DAC) 221, a phase modulation unit 223, and a first amplification unit 225 (e.g., a power amplifier).

The DAC 221 may obtain a binary code sequence and convert the binary code sequence into an analog signal.

The phase modulation unit 223 may generate a radar waveform in units of subframes by performing phase modulation on a carrier using a signal of M analog binary code sequences. Here, M is a constant greater than or equal to 1 and may be determined according to system requirements.

The first amplification unit 225 may amplify the radar waveform and transmit the radar waveform through the antenna 230. Thereafter, the radar waveform may be reflected from surrounding objects (targets or obstacles) and received by the antenna 230.

The reception module 240 may include a second amplification unit 241, a demodulation unit 242, a filter 243, an analog to digital converter (ADC) 244, a correlation operation bank block 245, and a Fourier transform unit 246.

When the second amplification unit 241 obtains the received radar waveform by the antenna 230, the second amplification unit 241 may amplify the radar waveform with low noise to amplify the waveform other than noise. The demodulation unit 242 may perform quadrature demodulation on the amplified signal with low noise and convert the quadrature demodulated signal into an I signal and a Q signal. The filter 243 may convert the demodulated I and Q signals into a baseband analog signal. The ADC 244 may convert the baseband analog signal into a baseband digital signal (hereinafter referred to as a “baseband signal”) through analog-to-digital conversion.

The correlation operation bank block 245 may perform a correlation operation between the baseband signal and the code sequence. The result of the correlation operation is used to check the time delay of the baseband signal, and the checked time delay may be used to estimate a range to the object.

The Fourier transform unit 246 may convert the result of the correlation operation into the frequency domain through fast Fourier transform processing. Accordingly, the Fourier transform unit 246 may detect a Doppler effect, which represents a change in frequency that occurs as an object (substance or target) moves in the frequency domain. Thereafter, the Doppler effect may be used to track or observe the movement or speed of the object.

Meanwhile, the signals generated or processed by the PMCW radar device 200 are mathematically analyzed as follows.

The binary code sequence may include L chips. The binary code sequence may be a single binary code sequence {a₀, a₁, . . . a_{L-1}} (0≤k<L) with a period of L. Each chip aₖ may have a value of −1 or 1 (aₖ∈{+1, −1}).

In addition, the radar waveform may be transmitted or processed in units of subframes or frames to estimate the distance, speed, and angle of an object. When the radar transmission waveform within one subframe is expressed as Bₙ(k), the transmission waveform may be expressed as Equation 1 below.

$${B}_{n} ( k ) = {a}_{k} , ( 0 \leq k < L , 0 \leq n < N M ) \qquad [ Equation 1 ]$$

In Equation 1 above, k may be a sequence number of the chip, and n may be a sequence number of each transmission waveform (a pulse, a chirp, or a fundamental waveform). M may be the number of accumulated pulses (or the number of transmission waveforms in a sub-frame, or the period of the transmission waveform), N may be the fast Fourier transform (FFT) magnitude (or the transmission period of the sub-frame), and N and M may each be a constant greater than or equal to 1.

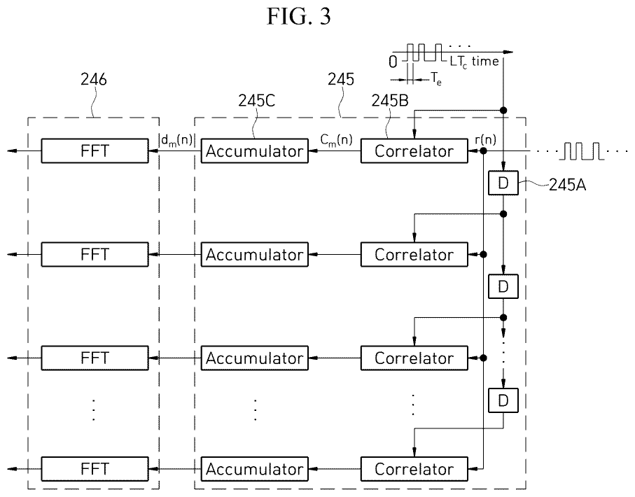

FIG. 3 shows a detailed configuration diagram of the digital processing part (e.g., the correlation operation bank block 245 and the Fourier transform unit 246) of the reception module according to an embodiment.

Referring to FIG. 3, the correlation operation bank block 245 may include a plurality of delayers 245A, a plurality of correlators 245B, and a plurality of accumulators 245C. (L−1) delayers 245A may be provided, and L correlators 245B and L accumulators 245C may be provided. However, this is only an embodiment, and it is not limited thereto. For example, the plurality of correlators 245B and the plurality of accumulators 245C may be provided in various numbers ranging from 1 to L or less.

Each of the plurality of delayers 245A may delay an input code sequence in the chip unit and output the delayed code sequence.

The plurality of correlators 245B may perform a correlation operation between the baseband signal and the code sequence (or the code sequence delayed in the chip unit). The baseband signal is a digital signal that has passed through the demodulation unit 242, the filter 243, and the ADC 244 after being received by the antenna 230, and may be expressed as r(n). The output signal of each correlator 245B may be expressed as Equation 2 below.

$${c}_{m} ( n ) = {\sum }_{k = 0}^{L - 1} {b}_{m} ( k ⊖ m ) \cdot r ( nL + k ) \qquad [ Equation 2 ]$$

In Equation 2 above, m is the order of the correlators 245B, and k⊖m is as shown in Equation 3 below.

$$k ⊖ m = \{ \begin{matrix}k - m , k \geq m \\ k + L - m , k < m\end{matrix} \qquad [ Equation 3 ]$$

The plurality of accumulators 245C may accumulate M signals cm (n) that have been subjected to a correlation operation and transmit the M accumulated signals to the Fourier transform unit 246. The plurality of accumulators 245C are used to obtain additional processing gain, and the overall processing gain may be determined by a product of the code sequence length L and the accumulation length M. Therefore, the PMCW radar device 200 may operate well even in situations where noise and interference are present. An output signal dₘ(n) of the m^{th} accumulator may be expressed as shown in Equation 4 below.

$${d}_{m} ( n ) = {\sum }_{k = 0}^{M - 1} {c}_{m} ( n M + k ) \qquad [ Equation 4 ]$$

However, a PMCW radar device using the code sequence of the same period L may be interfered with by another vehicle's radar device when a usage rate (or density) thereof increases. When the code sequence period of the PMCW radar device 200 is the same as that of another vehicle, the result of the correlation operation with the interference signal may be repeated similarly to a target signal (the result of the correlation operation with the transmitted signal). In this case, the interference signal is amplified in the same format as the target signal through the accumulators 245C, which may lead to a human casualty accident when the object is incorrectly detected. Hereinafter, the correlation operation result between the code sequences of the same period will be examined.

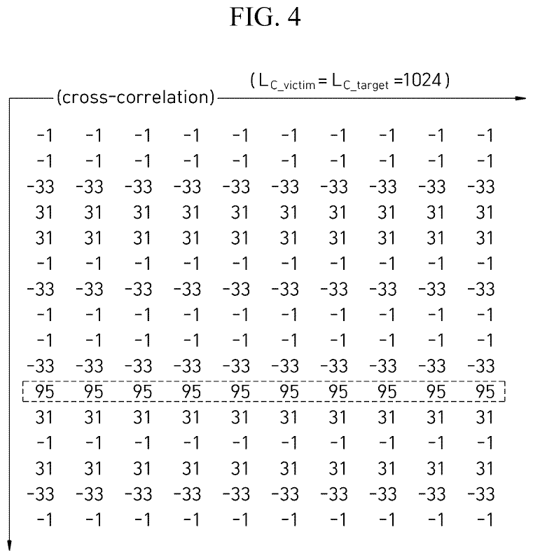

FIG. 4 shows correlation operation values between two different m-sequences when a code sequence period is L=1024.

As shown in FIG. 4, the correlation operation values between two m-sequences (code sequences having the same period) repeatedly appear as the same values. Furthermore, a specific correlation operation value (see the dotted rectangle in FIG. 4) increases to a non-negligible level. Therefore, when the specific correlation operation values are accumulated in the same manner as the vehicle's own received signal, performance of the PMCW radar device 200 may be degraded.

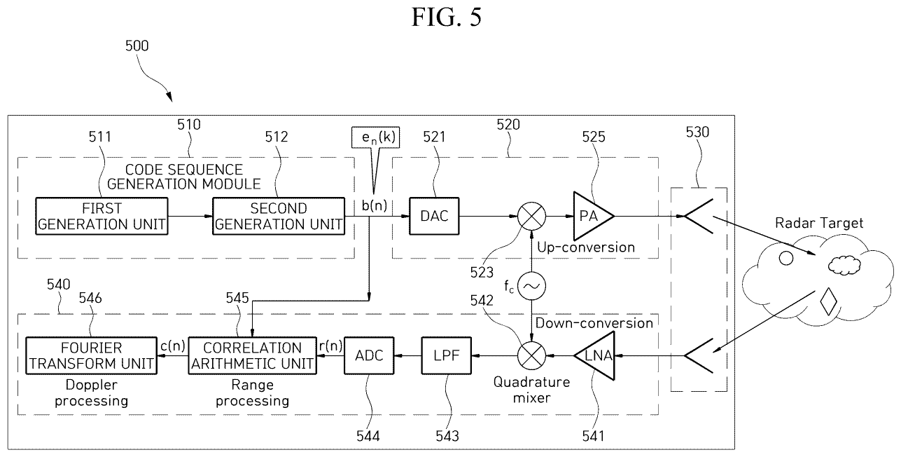

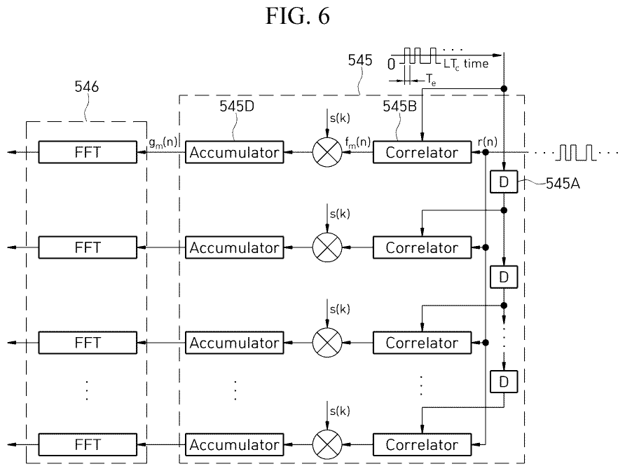

FIG. 5 shows a configuration diagram of a PMCW radar device according to an embodiment, and FIG. 6 shows a detailed configuration diagram of a digital processing block according to an embodiment.

Referring to FIG. 5, a PMCW radar device 500 according to the embodiment may include a code sequence generation module 510, a transmission module 520, a reception module 540, and an antenna 530.

According to an embodiment, the code sequence generation module 510 may include a first generation unit 511 and a second generation unit 512.

The first generation unit 511 may generate an outer code sequence s(n)={s(0), s(1), . . . s(NM−1)}. The first generation unit 511 may generate an outer code sequence in a specified scheme including random code generation.

The second generation unit 512 may generate an inner code sequence a(n)={a₀, a₁, . . . , a_{L-1}}. The inner code sequence may be a single code having a high auto-correlation characteristic and a low cross-correlation characteristic compared to a specified average value. The length of the inner code sequence may be L and the length of the outer code sequence may be M*N. The lengths (or periods) of the inner code sequence and the outer code sequence may be different from each other.

The code sequence generation module 510 may generate an integrated code sequence by concatenating the inner code sequence and the outer code sequence in a specified scheme. The integrated code sequence may be expressed as in Equation 4 below. For example, a k^{th} chip of the integrated code sequence may be generated by multiplying a k^{th} chip of the inner code sequence and a k^{th} chip of the outer code sequence by each other. Specifically, when a chip sequence number k is less than or equal to the length L of the inner code sequence, the code sequence generation module 510 may generate the k^{th} chip of the integrated code sequence by multiplying the k^{th} chip of the inner code sequence and the k^{th} chip of the outer code sequence. On the other hand, when the chip sequence number k exceeds the length L of the inner code sequence, the k^{th} chip of the integrated code sequence may be generated by multiplying a (k−L)th chip of the inner code sequence and the k^{th} chip of the outer code sequence.

$${e}_{n} ( k ) = s ( n ) \cdot {a}_{k \% L} , ( 0 \leq k \leq L MN , 0 \leq n \leq M N ) k \% L = \{ \begin{matrix}k , k < L \\ k - L , k \geq L\end{matrix} \qquad [ Equation 5 ]$$

The transmission module 520 may include an DAC 521, a modulator 523, and a first amplifier 525. The DAC 521 may convert the integrated code sequences into an analog signal. The modulator 523 may perform phase modulation on a carrier using M analog integrated code sequences and generate a radar transmission waveform in units of subframes (hereinafter referred to as “continuous wave”). The first amplifier 525 may amplify the radar transmission waveform.

The amplified continuous wave may be transmitted in a specified direction (directivity) through the antenna 530. Thereafter, the antenna 530 may receive the radar waveform reflected by the object.

The reception module 540 may generate a baseband signal by performing digital conversion on the reception signal, sequentially perform a correlation operation on the baseband signal with the inner code sequence and the outer code sequence, and operate an FFT on a result of the correlation operation.

The reception module 540 may include a second amplifier 541 (e.g., a low noise amplifier (LNA)), a demodulator 542, a filter 543, an ADC 544, a correlation arithmetic unit 545, and a Fourier transformer 546. The configurations of the second amplifier 541, the demodulator 542, the filter 543, and the ADC 544 are respectively identical or similar to those of the second amplification unit 241, the demodulation unit 242, the filter 243, and the ADC 244 of FIG. 2, and thus detailed description thereof is omitted. Hereinafter, the correlation arithmetic unit 545 will be described.

The correlation arithmetic unit 545 may include a plurality of delayers 545A, a plurality of correlators 545B, a plurality of multipliers 545C, and a plurality of accumulators 545D.

The plurality of delayers 545A may include first to (L−1)^{th} delayers. Each of the delayers 545A may delay an input integrated code sequence or a delayed integrated code sequence in the chip unit. For example, the first delayer may delay an integrated code sequence by Tc, the second delayer may obtain the integrated code sequence delayed by the first delayer by Tc and delay it again by Tc, and the remaining delayers may repeat the delay in this manner, thereby delaying the integrated code sequence in the chip unit. Therefore, the (L−1)^{th} delayer may output the integrated code sequence delayed by (L−1)*Tc.

The plurality of correlators 545B may include first to L^{th} correlators. The plurality of correlators 545B may perform a correlation operation between the baseband signal and the inner code sequence (or the inner code sequence delayed in the chip unit). For example, the first correlator may perform a correlation operation between a baseband signal and an inner code sequence, and the second correlator may perform a correlation operation between the baseband signal and the inner code sequence delayed by Tc. The L^{th} correlator may perform a correlation operation between the baseband signal and the inner code sequence delayed by (L−1)*Tc. An output signal fₘ(n) of the m^{th} correlator may be expressed as in Equation 6 below.

$${f}_{m} ( n ) = {\sum }_{k = 0}^{L - 1} {e}_{n} ( k ⊖ m ) \cdot r ( nL + k ) \qquad [ Equation 6 ]$$

The plurality of multipliers 545C may multiply the result signal fₘ(n) of the correlation operation as in Equation 6 above and an outer code sequence s(nM+k). As a result, the multipliers 545C may output the result signal fₘ(n) obtained by sequentially performing the correlation operation on the baseband signal with the inner code sequence and the outer code sequence.

The plurality of accumulators 545D may include first to L^{th} accumulators. Each accumulator may accumulate M result signals fₘ(n) obtained by sequentially performing the correlation operation on the baseband signal with the inner code sequence and the outer code sequence in units of subframes. An output signal of the m^{th} accumulator may be expressed as in Equation 7 below.

$${g}_{m} ( n ) = {\sum }_{k = 0}^{M - 1} s ( n M + k ) \cdot {f}_{m} ( n M + k ) \qquad [ Equation 7 ]$$

A plurality of Fourier transformers 546 may group N output signals of the accumulators 545D and perform a fast Fourier transform on the grouped signal. The plurality of Fourier transformers 546 may detect the Doppler effect, which represents a change in frequency that occurs due to the movement of an object (substance or target), in the frequency domain. The Doppler effect may be used to track or observe the movement or speed of an object.

In this way, an object detection apparatus 800 according to an embodiment may generate an integrated code sequence corresponding to one detection period by using a plurality of code sequences having different periods for correlation operations (e.g., an inner code sequence and an outer code sequence).

In addition, the object detection apparatus 800 according to an embodiment may randomize interference signals from other radars so that its own signal is coherently accumulated and the interference signals are randomly accumulated and ignored, by performing the correlation operation on the received radar waveform (baseband signal) using a plurality of code sequences. Therefore, the object detection apparatus 800 may robustly detect objects without performance degradation in various interference situations.

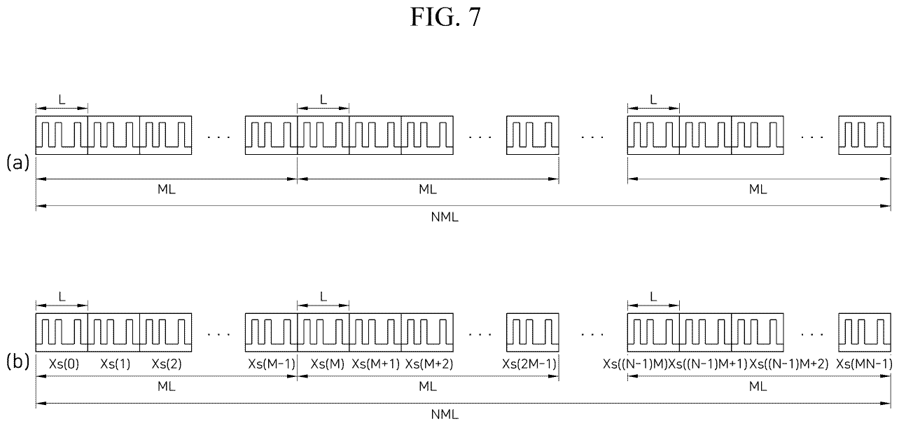

Hereinafter, the advantages and disadvantages of using a single code sequence and an integrated code sequence will be described with reference to FIG. 7.

FIG. 7 is a diagram illustrating a comparison of subframe structures according to a single code sequence and an integrated code sequence.

Referring to (A) of FIG. 7, a single code sequence-based subframe may have a structure in which a code sequence, in which an inner code sequence {a₀, a₁, . . . a_{L-1}} having a length L is repeated M times, is repeated N times. The correlation operation of the reception module 240 may be performed in units of L, the accumulation of the reception module 240 may be performed in units of M, and the FFT processing of the reception module 240 may be performed in units of N. Thus, subframe based on a single code sequence may only has a repetition period of L*M.

Meanwhile, referring to (B) of FIG. 7, a subframe based on a dual code sequence may have a very long repetition period L*N*M due to an outer code sequence. Therefore, the PMCW radar device 500 using the dual code sequence (the inner code sequence and the outer code sequence) may have a characteristic of being very robust to interference signals.

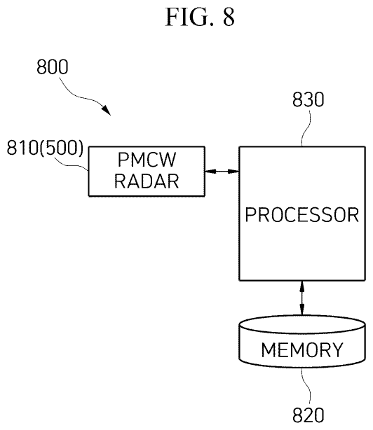

FIG. 8 shows a configuration diagram of an object detection apparatus according to an embodiment.

Referring to FIG. 8, an object detection apparatus 800 according to the embodiment may include a PMCW radar 810 (e.g., RMCW radar device 500), a memory 820, and a processor 830. In an embodiment, some components may be omitted or additional components may be further included in the object detection apparatus 800. In addition, some of the components of the object detection apparatus 800 may be combined to form a single entity, but the single entity may perform the same functions of the corresponding components before the combination. In an embodiment, the object detection apparatus 800 may be a vehicle system, such as a parking assistance system, a driver assistance system, or an autonomous driving system.

The memory 820 may include various types of volatile memory or nonvolatile memory. For example, the memory 820 may include a read only memory (ROM) and a random access memory (RAM). In an embodiment, the memory 820 may be located inside or outside the processor, and the memory 820 may be connected to the processor 830 through various known means. The memory 820 may store various types of data used by at least one component (e.g., the processor 830) of the object detection apparatus 800. The data may include, for example, input data or output data for software and instructions related thereto. For example, the memory 820 may store at least one instruction for PMCW radar-based object detection. The at least one instruction may cause the processor 830 to perform an operation of generating an integrated code sequence using an inner code sequence and an outer code sequence different from each other, an operation of grouping the integrated code sequence into a first specified number of sub-sequences after performing phase modulation on the integrated code sequence and transmitting the grouped integrated code sequence, an operation of performing digital conversion on a signal received after being transmitted and then reflected by a nearby object to generate a baseband signal, an operation of sequentially performing a correlation operation on the baseband signal with the inner code sequence and the outer code sequence and performing a fast Fourier transform on the result of the correlation operation, and an operation of detecting movement of the object based on a result of the fast Fourier transform.

The processor 830 may control at least one other component (e.g., a hardware or software component) of the object detection apparatus 800 and perform various data processing or computations. The processor 830 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

The processor 830 may control the PMCW radar 810 by executing at least one instruction. For example, the processor 830 may control the PMCW radar 810 to generate a continuous wave based on the dual code sequence (the inner code sequence and the outer code sequence) and transmit the continuous wave. The processor 830 may determine the range to the object based on the output of the correlation arithmetic unit 545. The processor 830 may check the Doppler effect based on the output of the Fourier transformer 546 and check at least one of the movement and speed of the object based on the Doppler effect.

In this way, the object detection apparatus 800 according to an embodiment may generate an integrated code sequence corresponding to one detection period by using a plurality of code sequences having different periods (e.g., an inner code sequence and an outer code sequence) for a correlation operation.

In addition, the object detection apparatus 800 according to an embodiment may randomize interference signals from other radars so that its own signal is coherently accumulated and the interference signals are randomly accumulated and ignored, by performing the correlation operation on the received radar waveform (baseband signal) using a plurality of code sequences. Therefore, the object detection apparatus 800 may robustly detect objects without performance degradation in various interference situations.

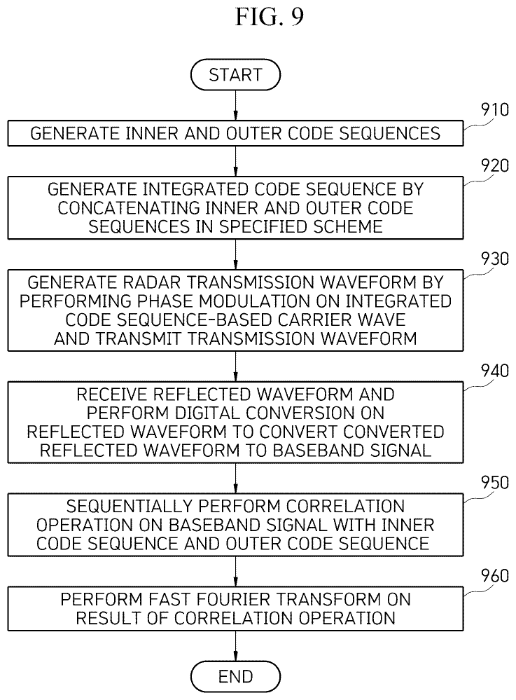

FIG. 9 shows a flowchart of a PMCW radar control method according to an embodiment.

Referring to FIG. 9, in operation 910, the object detection apparatus 800 may generate an inner code sequence and an outer code sequence. The inner code sequence and the outer code sequence may have independent contents and different periods.

In operation 920, the object detection apparatus 800 may generate an integrated code sequence by concatenating the inner code sequence and the outer code sequence in a specified scheme. For example, the object detection apparatus 800 may generate the integrated code sequence by multiplying the inner code sequence and the outer code sequence in the chip unit. However, when the sequence number of the integrated code sequence exceeds the period of the inner code sequence, the integrated code sequence may be generated reusing the outer code sequence with the inner code sequence starting from the first sequence number thereof.

In operation 930, the object detection apparatus 800 may generate a radar transmission waveform by performing phase modulation on a carrier using the integrated code sequence and transmit the transmission waveform. The object detection apparatus 800 may generate a radar transmission waveform including M integrated code sequences in units of subframes.

In operation 940, the object detection apparatus 800 may perform digital conversion on a signal received after being transmitted and then reflected by a nearby object to generate a baseband signal.

In operation 950, the object detection apparatus 800 may sequentially perform a correlation operation on the baseband signal with the inner code sequence and the outer code sequence. The object detection apparatus 800 may detect the range to the object based on the result signal of the correlation operation.

In operation 960, the object detection apparatus 800 may perform a fast Fourier transform on the result of the correlation operation. The object detection apparatus 800 may detect at least one of the movement or speed of the object based on a result of the fast Fourier transform.

It should be understood that the various embodiments of this document and the terms used therein are not intended to limit the technical features described in this document to specific embodiments, but rather to encompass various modifications, equivalents, or substitutes of the embodiments. In connection with the description of the drawings, similar reference numerals may be used for similar or related components. The singular form of a noun corresponding to an item may include one or more of the items, unless the context clearly indicates otherwise. In this document, each of phrases such as “A or B,” “at least one of A and B,” “at least one of A or B,” “A, B, or C,” “at least one of A, B, and C,” and “at least one of A, B, or C” may include any one of the items listed together with the corresponding phrase, or all possible combinations thereof. Terms such as “first,” “second,” “firstly” or “secondly” may be used simply to distinguish a component from another component and do not limit the components in any other respect (e.g., importance or order). When a component (e.g., a first component) is referred to as “coupled” or “connected” to another component (e.g., a second component), with or without the terms “functionally” or “communicatively,” it means that the component may be connected to the other component directly (e.g., in a wired manner), wirelessly, or through a third component.

The term “module” as used in this document may include a unit implemented in hardware, software, or firmware, and may be used interchangeably with terms such as logic, logic block, component, or circuit. A module may be a component that is integrally formed or may be the smallest unit or part of the component that performs one or more functions. For example, according to an embodiment, the module may be implemented in the form of an ASIC.

Various embodiments of this document may be implemented as software (e.g., a program) including one or more instructions stored in a storage medium (e.g., a memory 820 of FIG. 8) (e.g., a built-in memory or an external memory) that can be read by a machine (e.g., an object detection apparatus). For example, a processor (e.g., a processor 830) of a machine (e.g., an object detection apparatus 800) may call at least one instruction among one or more stored instructions from a storage medium and execute the at least one instruction. This enables the machine to be operated to perform at least one function according to the at least one instruction called. The one or more of the instructions may include code generated by a compiler or code executable by an interpreter. A storage medium readable by the machine may be provided in the form of a non-transitory storage medium. Here, “non-transitory” only means that the storage medium is a tangible device and does not contain a signal (e.g., electromagnetic waves), and this term does not distinguish between a case where data is stored semi-permanently and a case where it is stored temporarily in the storage medium.

According to an embodiment, the methods according to various embodiments disclosed in this document may be provided by being included in a computer program product. The computer program product may be traded between a seller and a buyer as a commodity. The computer program product may be distributed in the form of a machine-readable storage medium (e.g., a compact disc read only memory (CD-ROM)), or may be distributed online (e.g., downloaded or uploaded) through an application store (e.g., Play Store™) or directly between two user devices (e.g., smartphones). In the case of online distribution, at least a portion of the computer program product may be temporarily stored or temporarily generated in a machine-readable storage medium, such as a memory of a manufacturer's server, an application store's server, or a relay server.

The components according to various embodiments of this document may be implemented in the form of software or hardware, such as a digital signal processor (DSP), an FPGA, or an ASIC, and may perform certain roles. “Components” are not limited to software or hardware, and each component may be configured to reside on an addressable storage medium or configured to cause one or more processors to operate. As an example, a component may include components such as software components, object-oriented software components, class components, and task components, and processes, functions, attributes, procedures, subroutines, segments of program code, drivers, firmware, microcode, circuitry, data, databases, data structures, tables, arrays, and variables.

According to various embodiments, each component (e.g., module or program) of the components described above may include a single entity or a plurality of entities. According to various embodiments, one or more of the components or operations described above may be omitted, or one or more other components or operations may be added. Alternatively or additionally, a plurality of components (e.g., modules or programs) may be integrated into a single component. In such a case, the integrated component may perform one or more functions of each of the plurality of components identically or similarly to those performed by the corresponding component among the plurality of components prior to the integration. According to various embodiments, the operations performed by the module, program, or other component may be performed sequentially, in parallel, iteratively, or heuristically, or one or more of the operations may be performed in a different order or omitted, or one or more other operations may be added.

According to various embodiments disclosed in this document, interference between code sequences can be reduced. In addition, various effects that can be directly or indirectly identified through this document can be provided.

Although the present invention has been described in detail above with reference to exemplary embodiments, those of ordinary skill in the technical field to which the present invention pertains should be able to understand that various modifications and alterations can be made without departing from the technical spirit or essential features of the present invention. Therefore, it should be understood that the disclosed embodiments are not limiting but illustrative in all aspects. The scope of the present invention is defined not by the above description but by the following claims, and it should be understood that all changes or modifications derived from the scope and equivalents of the claims fall within the scope of the present invention.

What is claimed is:

1. A phase modulated continuous wave (PMCW) radar device comprising:
a code sequence generation module configured to generate an integrated code sequence by concatenating an inner code sequence and an outer code sequence in a specified scheme, wherein the inner code sequence and the outer code sequence are different binary code sequences;
a transmission module configured to generate a continuous wave by performing phase modulation on a carrier using the integrated code sequence and to transmit the continuous wave; and
a reception module configured to receive a signal of the continuous wave reflected by a nearby object, performs digital conversion on the received signal to generate a baseband signal, sequentially perform a correlation operation on the baseband signal with the inner code sequence and the outer code sequence, and perform a fast Fourier transform (FFT) operation on a result of the correlation operation.

2. The PMCW radar device of claim 1, wherein the code sequence generation module generates a k^{th} chip of the integrated code sequence by multiplying a k^{th} chip of the inner code sequence and a k^{th} chip of the outer code sequence.

3. The PMCW radar device of claim 2, wherein the code sequence generation module generates the k^{th} chip of the integrated code sequence by multiplying the k^{th} chip of the inner code sequence and the k^{th} chip of the outer code sequence when k is less than or equal to a length of the inner code sequence and generates the k^{th} chip of the integrated code sequence by multiplying a (k−L)^{th} chip of the inner code sequence and the k^{th} chip of the outer code sequence when k exceeds the length of the inner code sequence.

4. The PMCW radar device of claim 1, wherein the reception module includes:
a correlator performing a correlation operation between the baseband signal and the inner code sequence;
a multiplier multipling an output signal of the correlator and the outer code sequence;
an accumulator accumulating an output signal of the multiplier in units of a first specified number; and
a Fourier transform arithmetic unit performing a fast Fourier transform arithmetic operation on an output signal of the accumulator.

5. The PMCW radar device of claim 4, wherein the transmission module generates the continuous wave by performing phase modulation on the carrier using a first specified number of the integrated code sequences, and
the accumulator accumulates the output signal of the multiplier in units of the first specified number.

6. The PMCW radar device of claim 4, wherein the reception module further includes a delayer sequentially delaying the inner code sequence in a chip unit, and
the correlator performs a correlation operation between the baseband signal and the sequentially delayed inner code sequence.

7. The PMCW radar device of claim 6, wherein the correlator and the multiplier include a second specified number of correlators and the second specified number of multipliers, respectively, and
the second specified number of the multipliers multiply a result signal of a correlation operation performed by the second specified number of the correlators and the outer code sequence in the chip unit.

8. The PMCW radar device of claim 1, wherein the inner code sequence and the outer code sequence have different periods, and
the period of the outer code sequence corresponds to a product of the number of the integrated code sequences included in the continuous wave and the number of the continuous waves used for one-time object movement detection.

9. A phase modulated continuous wave (PMCW) radar control method comprising:
generating an inner code sequence and an outer code sequence, the inner code sequence and the outer code sequence being different binary code sequences;
generating an integrated code sequence using the inner code sequence and the outer code sequence;
transmitting a continuous wave generated by performing phase modulation on a carrier using the integrated code sequence;
performing digital conversion on a continuous wave received after being transmitted and then reflected by a nearby object to generate a baseband signal;
detecting a delay of the received continuous wave by sequentially performing a correlation operation on the baseband signal with the inner code sequence and the outer code sequence; and
detecting a Doppler effect by performing a fast Fourier transform on the result of the correlation operation.

10. The PMCW radar control method of claim 9, wherein the generating of the integrated code sequence includes generating a k^{th} chip of the integrated code sequence by multiplying a k^{th} chip of the inner code sequence and a k^{th} chip of the outer code sequence.

11. The PMCW radar control method of claim 10, wherein the generating of the k^{th} chip includes:
generating the k^{th} chip of the integrated code sequence by multiplying the k^{th} chip of the inner code sequence and the k^{th} chip of the outer code sequence when k is less than or equal to a length of the inner code sequence; and
generating the k^{th} chip of the integrated code sequence by multiplying a (k−L)^{th} chip of the inner code sequence and the k^{th} chip of the outer code sequence when k exceeds the length of the inner code sequence.

12. The PMCW radar control method of claim 9, wherein the performing of the digital conversion and fast Fourier transform includes:
performing a correlation operation between the baseband signal and the inner code sequence using a correlation arithmetic unit;
multiplying a result signal of the correlation operation and the outer code sequence using a multiplier;
accumulating an output signal of the multiplier using an accumulator; and
performing a fast Fourier transform on the accumulated signal using a Fourier transform unit.

13. The PMCW radar control method of claim 12, wherein the transmitting of the continuous wave includes grouping the integrated code sequence into a first specified number and transmitting the grouped code sequence, and
the accumulating of the output signal includes accumulating the output signal of the multiplier in units of the first specified number.

14. The PMCW radar control method of claim 12, wherein the performing of the digital conversion further includes sequentially delaying the inner code sequence in a chip unit, and
the performing of the correlation operation includes performing a correlation operation on the baseband signal and the inner code sequence sequentially delayed in the chip unit.

15. The PMCW radar control method of claim 14, wherein the correlator and the multiplier include a second specified number of correlators and the second specified number of multipliers, respectively, and
the multiplying of the result signal includes multiplying the inner code sequence delayed in the chip unit by the second specified number of correlators and the k^{th} outer code sequence.

16. The PMCW radar control method of claim 14, wherein the inner code sequence and the outer code sequence have different periods, and
the period of the outer code sequence corresponds to a product of a number of the integrated code sequences included in the continuous wave and a number of the continuous waves used for one-time object movement detection.

17. An object detection apparatus that detects an object using a vehicle radar, comprising:
a memory in which at least one instruction for detecting an object is stored; and
a processor that executes the at least one instruction,
wherein the at least one instruction is executed to perform:
generating an integrated code sequence using an inner code sequence and an outer code sequence different from each other;
grouping the integrated code sequence into a first specified number after performing phase modulation on the integrated code sequence and transmitting the grouped integrated code sequence;
performing digital conversion on a signal received after being transmitted and then reflected by a nearby object to generate a baseband signal;
sequentially performing a correlation operation on the baseband signal with the inner code sequence and the outer code sequence, and performing a fast Fourier transform on a result of the correlation operation; and
detecting movement of the object based on a result of the fast Fourier transform.

18. The object detection apparatus of claim 17, wherein the generating of the integrated code sequence includes generating a k^{th} chip of the integrated code sequence by multiplying a k^{th} chip of the inner code sequence and a k^{th} chip of the outer code sequence.

19. The object detection apparatus of claim 18, wherein the generating of the k^{th} chip includes:
generating the k^{th} chip of the integrated code sequence by multiplying the k^{th} chip of the inner code sequence and the k^{th} chip of the outer code sequence when k is less than or equal to a length of the inner code sequence; and
generating the k^{th} chip of the integrated code sequence by multiplying a (k−L)^{th} chip of the inner code sequence and the k^{th} chip of the outer code sequence when k exceeds the length of the inner code sequence.

20. The object detection apparatus of claim 17, wherein the performing of the digital conversion includes:
delaying the inner code sequence in a chip unit; and
performing a k^{th} correlation operation by multiplying the inner code sequence delayed in the chip unit and the k^{th} outer code sequence.
